(19) United States
(12) Patent Application Publication
(10) Pub. No.: US 2020/0302533 A1
(43) Pub. Date: Sep. 24, 2020

(54) BLOCKCHAIN-BASED EXCHANGE METHOD AND APPARATUS FOR AVAILABLE RESOURCE QUOTAS

(71) Applicant: ALIBABA GROUP HOLDING LIMITED, GRAND CAYMAN (KY)

(72) Inventor: Xinying YANG, HANGZHOU (CN)

(21) Appl. No.: 16/894,846

(22) Filed: Jun. 7, 2020

Related U.S. Application Data
(63) Continuation of application No. PCT/CN2019/073419, filed on Jan. 28, 2019.

(30) Foreign Application Priority Data
Jun. 13, 2018 (CN) 201810610233.1

(51) Int. Cl. G06Q 40/04; G06Q 10/10; G06Q 10/06; G06Q 20/12; G06Q 20/40; G06Q 50/18; G06F 16/23; G06F 9/50

(52) U.S. Cl. CPC G06Q 40/04; G06Q 10/10; G06Q 10/06315; G06F 9/5077; G06Q 20/405; G06Q 50/184; G06F 16/2379; G06Q 20/1235

(57) ABSTRACT

An example of blockchain-based exchange method comprises: selecting, by a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas; determining, by the management node respectively for the plurality of target nodes, a plurality of resource quotas; determining, by the management node respectively for the plurality of target nodes, virtual resource decrements corresponding to the plurality of resource quotas; constructing, by the management node, a quota exchange transaction comprising the determined virtual resource decrements corresponding to the plurality of target nodes, and adding, by the management node, the quota exchange transaction to the blockchain.

### CROSS-REFERENCE TO RELATED APPLICATIONS

The present application is a continuation application of PCT Application No. PCT/CN2019/073419 filed Jan. 28, 2019, which is based on and claims priority to Chinese Patent Application No. 201810610233.1, filed on Jun. 13, 2018, and entitled “BLOCKCHAIN-BASED EXCHANGE METHOD AND APPARATUS FOR AVAILABLE RESOURCE QUOTAS.” All of the above-identified applications are incorporated herein by reference in their entirety.

### TECHNICAL FIELD

Embodiments of the specification relate to the field of information technologies, and in particular, to a blockchain-based exchange method and apparatus for available resource quotas.

### BACKGROUND

In order to acquire earnings, creators of art works (such as musical works, literary works, fine art works, and the like) have long been licensing copyrights of the art works to publishers for use, and the publishers distribute the art works. In practice, a large part of the earnings generated during the distribution of the works belongs to the publisher, and only a small part can reach the creator.

With the development of blockchain technologies, it is possible to implement point-to-point distribution of copyright works based on a blockchain. In a blockchain network, a node may be a creator or a user of the work. The creator may circumvent the publisher and directly distribute the work to the user and obtain earnings.

At present, each blockchain node usually conducts a copyright use transaction by using a common market currency such as a digital currency (such as Bitcoin) or a legal tender (such as RMB) in an electronic form as a transaction medium.

For a copyright use event corresponding to the target work, the user node determines a payment amount, determines a currency of the payment amount as an expenditure corresponding to the payment amount, determines the currency of the payment amount as an income corresponding to the creator node, then constructs a copyright use transaction including the determined corresponding expenditure and the corresponding income of the creator node, and publishes the copyright use transaction to the blockchain. In this way, the creator may obtain earnings.

In addition to existing technologies, the creator may obtain earnings in more diverse ways.

### SUMMARY

Embodiments of the specification provide a blockchain-based exchange method and apparatus for available resource quotas. The technical solutions are as follows.

In some embodiments, a blockchain-based exchange method for available resource quotas, where a blockchain network includes a management node and several object nodes, each object node performing copyright use transactions by using virtual resources as transaction media, and the method includes: selecting, by the management node, the several object nodes as target nodes according to a selection rule; determining, for each target node, available resource quotas exchanged to the target nodes; the available resource quotas exchanged to the target nodes being used for determining earning increments corresponding to the target nodes; determining virtual resources of the available resource quotas as virtual resource decrements corresponding to the target nodes; and constructing a quota exchange transaction including the determined virtual resource decrements corresponding to the target nodes, and publishing the quota exchange transaction to a blockchain.

In some embodiments, a blockchain-based exchange apparatus for available resource quotas is provided, where a blockchain network includes the apparatus and several object nodes, each object node performing copyright use transactions by using virtual resources issued by the apparatus as transaction media, and the apparatus includes: a selection module configured to select the several object nodes as target nodes according to a selection rule; an available resource quota determining module configured to determine, for each target node, available resource quotas exchanged to the target nodes; the available resource quotas exchanged to the target nodes being used for determining earning increments corresponding to the target nodes; a virtual resource decrement determining module configured to determine virtual resources of the available resource quotas as virtual resource decrements corresponding to the target nodes; and a constructing and publishing module configured to construct a quota exchange transaction including the determined virtual resource decrements corresponding to the target nodes, and publish the quota exchange transaction to a blockchain.

In some embodiments, a blockchain-based exchange system for available resource quotas, including a management node and several object nodes, where each object node performs copyright use transactions by using virtual resources issued by the management node as transaction media; and the management node is configured to: select several object nodes as target nodes according to a selection rule; determine, for each target node, available resource quotas exchanged to the target nodes; the available resource quotas exchanged to the target nodes being used for determining earning increments corresponding to the target nodes; determine virtual resources of the available resource quotas as virtual resource decrements corresponding to the target nodes; construct a quota exchange transaction including the determined virtual resource decrements corresponding to the target nodes, and publish the quota exchange transaction to a blockchain.

In some embodiments, a method comprises: selecting, by a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas; determining, by the management node respectively for the plurality of target nodes, a plurality of resource quotas; determining, by the management node respectively for the plurality of target nodes, virtual resource decrements corresponding to the plurality of resource quotas; constructing, by the management node, a quota exchange transaction comprising the determined virtual resource decrements corresponding to the plurality of target nodes, and adding, by the management node, the quota exchange transaction to the blockchain.

In one embodiment, the method further comprises, before selecting the plurality of object nodes as the plurality of target nodes, presetting a plurality of work categories, and for each work category, establishing an association relationship between the plurality of object nodes and the plurality of work categories, wherein: selecting the plurality of object nodes as the plurality of target nodes comprises: selecting the plurality of object nodes as the plurality of target nodes according to a selection rule for each of the plurality of work categories.

In one embodiment, the selection rule comprises: an amount of remaining virtual resources corresponding to an object node is not less than a first threshold; and the remaining virtual resources corresponding to the object node correspond to a remainder after the virtual resource decrements are deducted from virtual resource increments corresponding to the object node stored on the blockchain.

In one embodiment, the selection rule comprises: during a statistical period, for each object node, an amount of the virtual resource increments generated based on copyright use transactions is not less than a second threshold.

In one embodiment, the method further comprises: receiving, by the management node from an object node, a refill request comprising a refill amount; deducting, by the management node, an amount of property equivalent to virtual resources of the refill amount from a property account corresponding to the object node; determining, by the management node, the virtual resources of the refill amount as virtual resource increments corresponding to the object node; and constructing, by the management node, a resource refill transaction comprising the determined virtual resource increments corresponding to the object node, and adding the resource refill transaction to the blockchain; wherein the selection rule comprises that: (1) an amount of remaining virtual resources corresponding to the object node is not less than a first threshold, and (2) a proportion of virtual resource increments corresponding to the object node being generated based on resource refill transactions is not greater than a designated proportion.

In one embodiment, the selection rule comprises a competitiveness representation value algorithm; selecting the plurality of object nodes as the plurality of target nodes comprises: determining, by the management node for each object node, a competitiveness representation value by using the competitiveness representation value algorithm, and selecting a preset quantity of object nodes as the target nodes according to the competitiveness representation value respectively corresponding to the each object node; and for the each object node, a larger competitiveness representation value increases a chance of being selected as a target node.

In one embodiment, determining, by the management node for the each object node, the competitiveness representation value by using the competitiveness representation value algorithm comprises: determining, by the management node for the each object node, the competitiveness representation value by using a characteristic parameter corresponding to the object node as an input of the competitiveness representation value algorithm, wherein the characteristic parameter corresponding to the object node comprises: (1) an amount of remaining virtual resources corresponding to the object node, the virtual resource remaining virtual resources corresponding to the object node corresponding to a remainder after the virtual resource decrements are deducted from virtual resource increments corresponding to the object node stored on the blockchain; (2) a proportion of virtual resource increments generated based on copyright use transactions to virtual resources of the amount of remaining virtual resources corresponding to the object node; and (3) during a statistical period, for the each object node, an amount of the virtual resource increments generated based on copyright use transactions.

In one embodiment, selecting the preset quantity of object nodes as the target nodes according to the competitiveness representation value respectively corresponding to the each object node comprises: sorting the plurality of object nodes in a descending order according to the competitiveness representation value; and selecting, from a first object node according to the descending order, one or more object nodes agreed by one or more corresponding users to become target nodes until a preset quantity of target nodes are selected.

In one embodiment, the method further comprises, before selecting the plurality of object nodes as the plurality of target nodes, acquiring by the management node in advance for each object node, an authorization type corresponding to the object node, the authorization type comprising a consent type, a query type, or a rejection type; and selecting, from the first object node according to the descending order, the one or more object nodes agreed by the one or more corresponding users to become target nodes until the preset quantity of target nodes are selected comprises: if the authorization type is the consent type, determining that a corresponding user agrees to determine the user's object node as the target node; if the authorization type is the query type, asking whether the corresponding user agrees to determine the user's object node as the target node; and if the authorization type is the rejection type, determining that the corresponding user does not agree to determine the user's object node as the target node.

In one embodiment, determining, by the management node respectively for the plurality of target nodes, the plurality of resource quotas comprises: determining, for each target node, an amount of remaining virtual resources corresponding to the each target nodes as a resource quota.

In one embodiment, determining, by the management node respectively for the plurality of target nodes, the plurality of resource quotas comprises: determining a minimum amount of designated remaining virtual resources from a plurality of amounts of designated remaining virtual resources corresponding to the target nodes; designating, as a minimum amount of remaining virtual resources, an amount not greater than the minimum amount of designated remaining virtual resources; and determining, for each target node, the minimum amount of remaining virtual resources as a resource quota.

In some embodiments, a non-transitory computer-readable storage medium stores instructions executable by one or more processors, wherein execution of the instructions causes the one or more processors to perform operations comprising: selecting, at a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas; determining, at the management node respectively for the plurality of target nodes, a plurality of resource quotas; determining, at the management node respectively for the plurality of target nodes, virtual resource decrements corresponding to the plurality of resource quotas; constructing, at the management node, a quota exchange transaction comprising the determined virtual resource decrements corresponding to the plurality of target nodes; and adding, at the management node, the quota exchange transaction to the blockchain.

In some embodiments, a system comprises one or more processors and one or more non-transitory computer-readable storage media storing instructions executable by the one or more processors, wherein execution of the instructions causes the one or more processors to perform operations comprising: selecting, at a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas; determining, at the management node respectively for the plurality of target nodes, a plurality of resource quotas; determining, at the management node respectively for the plurality of target nodes, virtual resource decrements corresponding to the plurality of resource quotas; constructing, at the management node, a quota exchange transaction comprising the determined virtual resource decrements corresponding to the plurality of target nodes; and adding, at the management node, the quota exchange transaction to the blockchain.

According to the technical solutions provided by the embodiments of the specification, the blockchain network includes a management node and an object node, where each object node performs copyright use transactions by using virtual resources issued by the management node as transaction media. An object node may deliver virtual resources as a user party in some copyright use events, and receive virtual resources as a creator party in some copyright use events. For any object node, when available resource quotas are distributed to the object node by the management node, the object node party is capable of acquiring earnings (the available resource quotas are used for determining earning increments corresponding to the object node). In addition, the available resource quotas distributed to the object node need to be exchanged using the virtual resources possessed by the object node.

The foregoing general description and detailed description in the following are merely exemplary and interpretive, and cannot constitute a limitation to the embodiments of the specification.

In addition, any of the embodiments of the specification does not need to achieve all the effects described above.

### BRIEF DESCRIPTION OF THE DRAWINGS

To describe the technical solutions in the embodiments of the specification or in the existing technologies more clearly, the following briefly describes the accompanying drawings required for describing the embodiments or the existing technologies. Apparently, the accompanying drawings in the following description show merely some embodiments recorded in the embodiments of the specification, and persons of ordinary skill in the art may still derive other drawings from these accompanying drawings.

FIG. 1 is a schematic flowchart of a blockchain-based exchange method for available resource quotas according to an embodiment of the specification.

FIG. 2 is a schematic flowchart of a blockchain-based collective exchange method for available resource quotas according to an embodiment of the specification.

FIG. 3 is a schematic flowchart of a blockchain-based pre-exchange method for available resource quotas according to an embodiment of the specification.

FIG. 4 is a schematic structural diagram of a blockchain-based exchange apparatus for available resource quotas according to an embodiment of the specification.

FIG. 5 is a schematic structural diagram of a blockchain-based exchange system for available resource quotas according to an embodiment of the specification.

FIG. 6 is a schematic structural diagram of a blockchain-based collective exchange apparatus for available resource quotas according to an embodiment of the specification.

FIG. 7 is a schematic structural diagram of a blockchain-based collective exchange system for available resource quotas according to an embodiment of the specification.

FIG. 8 is a schematic structural diagram of a blockchain-based pre-exchange apparatus for available resource quotas according to an embodiment of the specification.

FIG. 9 is a schematic structural diagram of a blockchain-based pre-exchange system for available resource quotas according to an embodiment of the specification.

FIG. 10 is a schematic structural diagram of a computer device configured for an embodiment method of the specification.

### DETAILED DESCRIPTION OF THE INVENTION

A transaction (transfer) described in this specification refers to a piece of data that is created by a user through a client of a blockchain and that needs to be finally published to a distributed database of the blockchain.

The transaction in the blockchain includes transaction in a narrow sense and in a broad sense. The narrow-sense transaction refers to a value transaction issued by the user to the blockchain. For example, in a traditional Bitcoin blockchain network, a transaction may be a transaction initiated by the user in the blockchain. The broad-sense transaction refers to a piece of transaction data with a transaction intents issued by the user to the blockchain. For example, an operator may build an consortium blockchain based on actual transaction requirements, and rely on the consortium blockchain to deploy some other types of online transaction (for example, renting transaction, vehicle scheduling transaction, insurance claims transaction, credit services, medical service, and the like) that are not related to value transfer. However, in this type of consortium blockchain, the transaction may be a service message or a service request with a transaction intent issued by the user in the consortium blockchain.

In existing technologies, publishing a copyright use transaction to the blockchain means that a user node of the work transfers to a creator (usually the copyright owner of the work) of the work based on a copyright use event, and a transfer record is stored in the blockchain for publication. The copyright use event refers to all events involving the use of copyright works, for example, buying a novel, buying composed songs of creators, downloading music, and the like.

A main feature of the existing blockchain-based copyright transaction model is that each node in the blockchain network uses a common currency of the market as a transaction medium to conduct copyright use transactions. This means that the common currency in the market obtained by the creator node for distributing the work is earnings obtained by the creator.

However, the technical solutions provided by the specification enrich the way in which the creator of the work acquires earnings.

For example, in the embodiment of the specification, the blockchain network includes a management node and an object node, each object node performing copyright use transactions by using virtual resources issued by the management node as transaction media.

Therefore, the specification provides a blockchain-based method for delivering virtual resources. A blockchain network includes a management node and several object nodes, where each object node performs copyright use transactions by using virtual resources issued by the management node as transaction media, and the blockchain-based method for delivering virtual resources includes: determining, by user nodes for a copyright use event corresponding to a target work, a delivery amount, the user node being an object node corresponding to a user that uses the target work; determining, by the user node, virtual resources of the delivery amount as virtual resource decrements corresponding to the user nodes, and determining the virtual resources of the delivery amount as virtual resource increments corresponding to creator nodes; the creator nodes being object nodes corresponding to users that create the target work; and constructing, by the user nodes, copyright use transactions including the determined virtual resource decrements corresponding to the user nodes and the virtual resource increments corresponding to the creator nodes, and publishing the copyright use transactions to the blockchain, where the virtual resource is actually electronic data, of which a specific form may be game coins, points, virtual items, and the like.

The delivery amount is for example an amount of virtual resources required to use the target work, which may be preset by the creator of the target work.

In other words, in the foregoing method for delivering the virtual resources, publishing copyright transactions to the blockchain means that the user nodes of the work deliver the virtual resources to the creators (who are usually copyright owners of the works) of the work based on a copyright use event, and a virtual resource delivery record is stored in the blockchain for publication.

Through the foregoing method for delivering the virtual resources, an object node may deliver virtual resources as a user in some copyright use events, and collect the virtual resources as a creator in some copyright use events. A virtual resource delivery record corresponding to each copyright use event is to be stored in the blockchain for publication. Based on the record of the delivered virtual resources stored on the blockchain, remaining virtual resources corresponding to each object node may be determined.

In the foregoing method for delivering the virtual resources, for each object node, the object node may not only collect virtual resources delivered by other object nodes based on the copyright use transactions, but also request the management node responsible for issuing the virtual resources to deliver virtual resources to the object nodes with or without payment.

For example, the manner in which the management node delivers the virtual resources for a fee is as follows.

The management node receives a refill request that includes a refill amount and that is sent by any object node, deducts property equivalent to virtual resources of the refill amount from a property account of the user corresponding to the object node, determines the virtual resources of the refill amount as the virtual resource increments corresponding to the object nodes, constructs a resource refill transaction including the determined virtual resource increments corresponding to the object nodes, and publishes the resource refill transaction to the blockchain.

The specification further provides a blockchain-based exchange method for available resource quotas. For any object node, when available resource quotas are distributed to the object node by the management node, the object node party is capable of acquiring earnings (the available resource quotas are used for determining earning increments corresponding to the object node). In addition, the available resource quotas distributed to the object node need to be exchanged using the virtual resources possessed by the object node.

The specification further provides another blockchain-based exchange method for available resource quotas. For any set of object nodes, when the set of object nodes is selected as a target object by the management node, each object node in the set of object nodes may obtain certain available resource quotas used for determining corresponding earning increments. In addition, the available resource quotas distributed to an object node need to be exchanged using the virtual resources possessed by the object node.

The specification further provides a blockchain-based pre-exchange method for available resource quotas. For any object node, when the object node is selected as a pre-exchanged node by the management node, the object node party is capable of obtaining a qualification for pre-exchanging certain available resource quotas, and withdraws earnings in advance based on the pre-exchanged available resource quotas. In addition, the object node needs to repay the virtual resources of the pre-exchanged available resource amount with a future virtual resource income as a guarantee.

The foregoing technical solution provided by the specification may be applied to a copyright trading scenario of any type of works (such as fine arts, music, and literature). For the convenience of description, a music copyright transaction scenario is used as an example in the following description. In this scenario, the virtual resources may be referred to as “musical tone coins.” Those skilled in the art should understand that this does not constitute a limitation on the specification.

In order to enable those skilled in the art to better understand technical solutions in embodiments of the specification, the technical solutions in the embodiments of the specification are described in detail below with reference to the drawings in the embodiments of the specification. Obviously, the described embodiments are only a part of the embodiments of the specification, other than all of the embodiments. Based on the embodiments in the specification, all other embodiments obtained by those skilled in the art should fall within the protection scope.

The technical solutions provided in the embodiments of the specification are described in detail below with reference to the drawings.

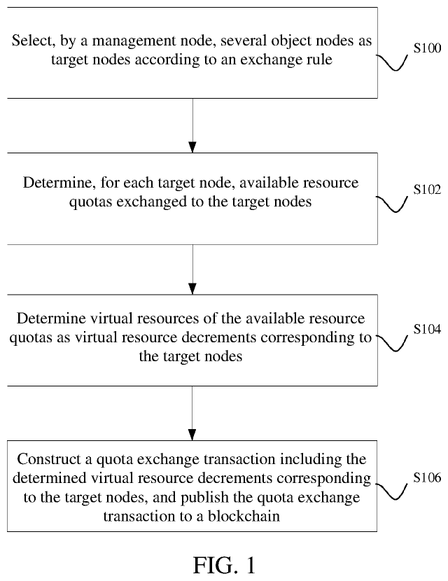

FIG. 1 is a schematic flowchart of a blockchain-based exchange method for available resource quotas according to an embodiment of the specification, including the following steps.
S100: A management node selects several object nodes as target nodes according to a selection rule. In some embodiment, S100 includes selecting, by a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas.

In this specification, a node may comprise a device with a data processing function and a communication function.

Nodes in the blockchain network are divided into a management node and an object node. Generally, for any object node, the object node may be used as a user node of work A to deliver virtual resources to a creator node of work A; or may be used as a creator node of work B to collect virtual resources delivered by the user node of work B.

The management node may not a participant (a user or a creator) of a copyright use event, but a manager of the entire copyright transaction system. The transaction media (that is, virtual resources) used by each object node are issued by the management node, which means that in the copyright transaction system, virtual resources may be used as transaction media. However, beyond the scope of the copyright transaction system, virtual resources may not necessarily be used as transaction media. For example, the virtual resources issued by the management node may not be able to purchase various merchandises in the market. Therefore, for the creator node of a work, collecting virtual resources does not necessarily mean obtaining earnings.

In the embodiment of the specification, the management node may perform step S100 once, periodically (such as once a month), or irregularly. Further, the management node may perform the exchange method for available resource quotas shown in FIG. 1 once, periodically (such as once a month), or irregularly.

In the embodiments of the specification, the selection rules may be specified according to actual transaction needs. For example, the management node may randomly select ten object nodes as target nodes according to the selection rule. For another example, the management node may successively select ten object nodes as target nodes according to remaining virtual resources corresponding to each object node.

For any object node, the remaining virtual resources corresponding to the object nodes are the remaining virtual resource after the virtual resource decrements that correspond to the target nodes and that are stored on the blockchain are deducted from the virtual resource increments that correspond to the object nodes and that are stored on the blockchain.

Further, several work categories may be preset, and for each work category, an association relationship between the several object nodes and the work category is established. For example, several work categories (rock, country, jazz, and the like) may be preset according to different music styles, then for each object node, at least one work category preferred by the object node is obtained, and an association relationship between the object node and the work category preferred by the object node is established. Assuming that a user A corresponding to an object node A is a jazz singer and a rock music lover, then a relationship between the object node A and the category of jazz may be established, and a relationship between the object node A and the category of rock is established.

In this way, in the embodiments of the specification, the management node may select, according to the selection rule for each work category, several object nodes from the object nodes associated with the work category as target nodes. For example, the management node may select ten object nodes as target nodes from object nodes associated with rock music, select six object nodes as target nodes from object nodes associated with country music, and select two object nodes as target nodes from object nodes associated with jazz music according to the selection rule.

Further, smart contract technologies may be used to ensure that the management node selects the target node in strict accordance with the selection rule. For example, in step S100, the management node may invoke a smart selection contract that includes the selection rule and that is stored on the blockchain, and select several object nodes as target nodes through the smart selection contract. The smart selection contract may refer to a smart contract of blockchain, and the smart contract comprises computer code executable to make selection of target nodes. For example, the computer code may comprises the selection rule. The smart selection contract is stored in the blockchain after consensus verification of each node in the blockchain network succeeds in advance.
S102: For each target node, available resource quotas exchanged to the target nodes are determined. In some embodiments, S102 includes determining, by the management node respectively for the plurality of target nodes, a plurality of resource quotas.

The several selected target nodes may be the object nodes that are eligible to exchange available resource quotas. For each target node, the available resource quotas exchanged to the target nodes are used for determining earning increments corresponding to the target nodes.

In the embodiments of the specification, there are a plurality of ways to determine the available resource quotas that are exchanged to each target node.

For example, for each target node, available resource quotas exchanged to the target nodes are determined according to a request of the target node. That is, for each target node, an amount of designated remaining virtual resources corresponding to the target nodes is determined as the available resource quotas exchanged to the target nodes. The amount of designated remaining virtual resources corresponding to the target nodes is an amount that is preassigned by a user corresponding to the target node and that is of at least one part of remaining virtual resources corresponding to the target nodes.

The available resource quotas exchanged to each target node may also be determined to be the same value. For example, for each target node, a minimum amount of remaining virtual resources may be determined as available resource quotas exchanged to the target nodes. The minimum amount of remaining virtual resources is determined in the following manners: determining a minimum amount of designated remaining virtual resources from the amounts of designated remaining virtual resources respectively corresponding to each target node; and designating, as the minimum amount of remaining virtual resources, an amount not greater than the minimum amount of designated remaining virtual resources.
S104: Virtual resources of the available resource quotas are determined as virtual resource decrements corresponding to the target nodes. In some embodiments, S104 includes determining, by the management node respectively for the plurality of target nodes, virtual resource decrements corresponding to the plurality of resource quotas.
S106: A quota exchange transaction including the determined virtual resource decrements corresponding to the target nodes is constructed, and the quota exchange transaction is published to a blockchain. In some embodiments, S106 includes constructing, by the management node, a quota exchange transaction comprising the determined virtual resource decrements corresponding to the plurality of target nodes; and adding, by the management node, the quota exchange transaction to the blockchain.

In the embodiment of the specification, since available resource quotas issued to a target node need to be exchanged with the virtual resources possessed by the target node, through steps S104 to S106, the virtual resources of the available resource quotas are deducted from the remaining virtual resources corresponding to the target node, the deduction record being publicly disclosed on the blockchain.

Through the blockchain-based exchange method for available resource quotas shown in FIG. 1, for the creator node of the work, the virtual resources collected by distributing the work are not directly implemented as earnings. If the creator node wants to obtain earnings, the creator node not only needs to be selected as the target node by the management node and possess the qualification for exchanging the available resource quotas, but also needs to expend the possessed virtual resources to exchange certain available resource quotas. The available resource quotas that are exchanged may be used to determine earning increments corresponding to the creator, so that the creator may obtain earnings.

In addition, in step S100, the management node may determine, according to the selection rule, an object node that satisfies the selection rule as a target node.

Each object node satisfies the selection rule including at least one of the following rules.

Rule 1: An amount of designated remaining virtual resources corresponding to the object nodes is not less than a first threshold.

Rule 2: During a statistical period, an amount of the virtual resource increments that correspond to the object node and that are generated based on the copyright use transaction is not less than a second threshold.

For the rule 1, the amount of designated remaining virtual resources corresponding to the object nodes is an amount that is preassigned by a user corresponding to the object node and that is of at least one part of remaining virtual resources corresponding to the object nodes. An amount of designated remaining virtual resources corresponding to an object node means that the user corresponding to the object node designates most of the remaining virtual resources for the selection.

For example, for object nodes A and B, remaining virtual resources (which may be musical tone coins) corresponding to the target node A are five musical tone coins, and remaining virtual resources corresponding to the object node B are eight musical tone coins. If the user A corresponding to the object node A designates, in advance, all of the musical tone coins for the selection, an amount of the designated remaining virtual resources corresponding to the object node A is five. If the user B corresponding to the object node B designates, in advance, seven musical tone coins possessed to participate in the selection, an amount of the designated remaining virtual resources corresponding to the object node A is seven.

The first threshold may be a fixed value specified according to actual transaction requirements. In the foregoing example, if the first threshold is 6, and an amount of the designated remaining virtual resources corresponding to the object node A is 5, the object node A does not satisfy the rule 1, and the object node B satisfies the rule 1.

In addition, if the management node conducts a selection on a regular basis, the first threshold may be different in each selection, that is, the first threshold is dynamically changed. This is because the amount of the designated remaining virtual resources corresponding to each object node may change at any time. For example, it is assumed that the management node selects 10 object nodes as target nodes from 100 object nodes periodically (once a month). For each selection, according to the current amounts of the designated remaining virtual resources corresponding to each object node, object nodes are sorted to determine the amount of designated remaining virtual resources corresponding to the 10^{th} object node as the first threshold.

It may be learned that the rule 1 means that the management node should select the object node with a larger amount of designated remaining virtual resources as the target node. If the amount of designated remaining virtual resources corresponding to each management node is the amount of corresponding remaining virtual resources, then the rule 1 means that more virtual resources possessed by an object node lead to a higher priority that the management node assigns the object node the qualification for exchanging available resource quotas.

Further, the rule 1 may be that, the amount of designated remaining virtual resources corresponding to the object nodes is not less than the first threshold, and a proportion of virtual resource increments generated based on the resource refill transaction to the remaining virtual resources of the amount of designated remaining virtual resources corresponding to the object nodes is not greater than a designated proportion. The designated ratio may be specified according to actual needs, for example, may be 80%. The purpose is to prevent some object nodes from increasing corresponding remaining virtual resources through recharging in order to be selected as the target node.

For the rule 2, the statistical period may be specified according to transaction needs. For example, the management node selects the target node once every month. When the management node performs the selection in May of this year, the statistical period may be designated as April 1 to April 30.

The rule 2 means that, for an object node, during the statistical period, more virtual resources the object node collects as the creator node lead to a higher priority that the management node assigns the object node the qualification for exchanging available resource quotas.

Similar to the first threshold, the second threshold may be a fixed value specified according to actual service requirements. In addition, if the management node conducts a selection on a regular basis, the second threshold may be different in each selection, that is, the second threshold is dynamically changed. This is because the statistical periods corresponding to each selection are different. During a plurality of statistical periods, virtual resource increments that correspond to the object node and that is generated based on the copyright use transaction may change.

For example, it is assumed that the management node selects 10 object nodes as target nodes from 100 object nodes periodically (once a month). For each selection, within the statistical period corresponding to the selection, according to the virtual resource increments that correspond to each object node and that is generated based on the copyright use transaction, object nodes are sorted to determine the amount of virtual resource increments corresponding to the 10^{th} object node as the first threshold.

In addition, in step S100, the management node may determine, according to the selection rule, an object node that satisfies the selection rule; determine, for each object node that satisfies the selection rule, whether a user corresponding to the object node agrees to determine the object node as the target node; and if the user agrees, determine the object node as the target node.

The management node acquires, in advance for each object node, an authorization type corresponding to the object node, the authorization type including one of a consent type, a query type, and a rejection type.

Based on this, for an object node, the determining whether a user corresponding to the object node agrees to determine the object node as the target node may include: if the authorization type corresponding to the object node is the consent type, determining that a user corresponding to the object node agrees to determine the object node as a target node; if the authorization type corresponding to the object node is the query type, asking whether the user corresponding to the object node agrees to determine the object node as the target node; and if the authorization type corresponding to the object node is the rejection type, determining that the user corresponding to the object node does not agree to determine the object node as the target node.

In addition, in the embodiment of the specification, a target node may be selected from the object nodes by calculating a competitiveness representation value corresponding to each object node. In this case, the selection rule is actually a competitiveness representation value algorithm.

For example, in step S100, the management node may calculate, for each object node, a competitiveness representation value corresponding to the object node by using the competitiveness representation value algorithm, and select a preset quantity of object nodes as target nodes according to the competitiveness representation value respectively corresponding to each object node. For each object node, a larger competitiveness representation value corresponding to the object node leads to a higher priority that the object node is selected as the target node.

In practical applications, a competitiveness representation value algorithm may be specified according to actual transaction needs. Here is an example.

The management node may calculate, for each object node, a competitiveness representation value corresponding to the object node by using a characteristic parameter corresponding to the object node as an input of the competitiveness representation value algorithm.

The characteristic parameter corresponding to the object node includes at least one of the following.

Characteristic parameter 1: an amount of designated remaining virtual resources corresponding to the object nodes. The meaning of the amount of designated remaining virtual resources has been described above, and details are not described again.

Characteristic parameter 2: a proportion of virtual resource increments generated based on a copyright use transaction to virtual resources of the amount of designated remaining virtual resources corresponding to the object nodes.

Characteristic parameter 3: during a statistical period, an amount of the virtual resource increments that correspond to the object node and that are generated based on the copyright use transaction.

In some embodiments, the composition of the characteristic parameters corresponding to each object node is the same. For example, assuming that the characteristic parameters corresponding to the object node are a characteristic parameter 1 and a characteristic parameter 2, then the characteristic parameters corresponding to each object node are all the characteristic parameter 1 and the characteristic parameter 2.

For example, the embodiment of the specification provides a formula for calculating a competitiveness representation value as follows:

∂*(a*X+b*Y);

X is the characteristic parameter 1, Y is the characteristic parameter 3, a is a weight corresponding to X, and b is a weight corresponding to Y. When the characteristic parameter 2 is greater than a specified ratio, a is 1, and when the characteristic parameter 2 is not greater than the specified ratio, a is 0.

Further, a specific method of selecting a preset quantity of object nodes as target nodes according to a competitiveness representation value respectively corresponding to each object node is: sorting object nodes in descending order according to the competitiveness representation value respectively corresponding to each object node; selecting a first object node; determining whether a user corresponding to the object node agrees to determine the object node as the target node; if the user agrees, determining the object node as the target node; if the user does not agree, skipping determining the object node as the target node; and selecting a next object node until a preset quantity of target nodes are determined.

In addition, in practical applications, the management node may specify a conversion ratio between available resource quotas and increment earnings, and calculate earning increments corresponding to the target node according to the conversion ratio and the available resource quotas exchanged to a target node. For example, the conversion ratio may be specified as 1:100, that is, an available resource quota is 1, and an earning increment that may be converted is 100 yuan.

The conversion ratio is not necessarily a purchase ratio on which the object node purchases virtual resources from the management node. For example, the object node needs to spend 80 yuan to purchase 1 musical tone coin from the management node, and the available resource quota is 1, which may be converted into an earning increment of 100 yuan.

The manager party corresponding to the management node may dynamically adjust the conversion ratio and the purchase ratio according to actual transaction needs.

The earning increment corresponding to the target node may be paid by the user corresponding to the management node to the user corresponding to the target node, or may be paid by other organizations or individuals to the user corresponding to the target node. In fact, it may be agreed in advance depending on the specific situation.

Herein, the technical solution is combined with an actual application scenario to exemplify the technical solution. The following exemplary description is merely to help understand the present solution, and does not constitute a limitation on the implementation of the present solution.

A music company X builds a blockchain-based music copyright transaction system in order to cultivate copyright payment habits of a user. In the music copyright transaction system, a server of the music company X serves as a management node, issues musical tone coins, and music writers or music listeners as object nodes, and uses musical tone coins as transaction media to conduct copyright use transactions.

For music writers, a main source of earning music coins is usually a behaviour of delivering musical tone coins by music listeners in the event of copyright use. For music listeners, a main source of earning musical tone coins is purchasing the musical tone coins with their own property by initiating a resource refill request to the management node (assuming that it costs 80 yuan to buy 1 musical tone coin). The music company X wants to give music writers more opportunities to convert musical tone coins based on copyright use transaction earnings into available resource quotas, and to limit music listeners as much as possible to convert refilled musical tone coins into available resource quotas.

To this end, the server of the music company X periodically (for example, every quarter) performs the exchange method for available resource quotas shown in FIG. 1. The strategy for the server of the music company X to select target nodes is as follows.

1. The object nodes are sorted in descending order according to an amount (which is designated by the user corresponding to each object node in advance and varies from person to person, the amount of designated remaining virtual resources of the musical tone coins may be the amount of the remaining virtual resources of the musical tone coins, or may be less than the amount of remaining virtual resources of the musical tone coins), and the first 100 object nodes are selected to form a list 1.

2. The object nodes are sorted according to a magnitude of musical tone coin increments (that is, a musical tone coin income) that are of each object node and that are generated based on copyright use transactions in the previous quarter, and the first 100 object nodes are selected to form a list 2.

3. An object node with more than 80% remaining virtual resources of musical tone coins coming from musical tone coins generated based on copyright use is selected from the object nodes, to form a list 3.

Then, based on the lists 1 to 3, object nodes that simultaneously appear in the three lists are determined as candidate nodes. For each candidate node, it is determined whether the user corresponding to the candidate node agrees to exchange available resource quotas, candidate nodes that do not agree to exchange available resource quotas are excluded, and the remaining candidate nodes are determined as target nodes.

The music company X determines a minimum value of the amount of the designated remaining virtual resources of musical tone coins as the available resource quota (assumed to be 1000) according to the amount of designated remaining virtual resources of musical tone coins corresponding to each target node. Then, through a consensus mechanism of the blockchain, 1,000 musical coins are deducted from the remaining virtual resources of the musical tone coins of each target node. According to regulations of the music company X, the available resource quota is 1, which may be converted into earning increments of 100. Then, a resource quota is 1,000, and the corresponding earning increment may reach 100,000 yuan.

For any target node, if the user (generally a music author selected through the foregoing selection rule) corresponding to the target node provides artistic service (such as attending commercial performances, composing music for others, and the like) in real life, in addition to the commission (assumed to be 50,000 yuan) for providing service, the user corresponding to the target node may further obtain a reward of 100,000 yuan from the music company X. In other words, the user corresponding to the target node obtains earnings of 15 yuan through an art service.

If the user corresponding to the target node refuses to provide art services for others in real life, the available resource quota corresponding to the target node cannot be temporarily converted into earning increments paid to the user.

In this way, the art company builds a music copyright transaction system in a virtuous circle. Through the operation of the music copyright transaction system, first, habits of music listeners paying for music are cultivated; and second, an earning incentive mechanism is formed for music writers, to encourage music writers to create more works loved by music listeners and provide art services for others in real life.

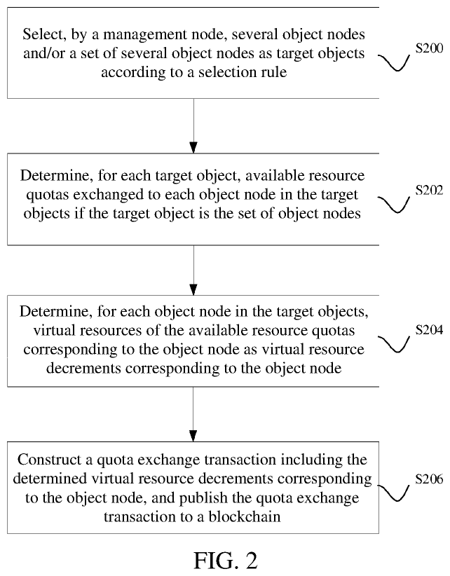

FIG. 2 is a schematic flowchart of a blockchain-based collective exchange method for available resource quotas according to an embodiment of the specification, including the following steps.
S200: The management node selects several object nodes and/or a set of several object nodes as target objects according to a selection rule.
S202: For each target object, available resource quotas exchanged to each object node in the target objects are determined if the target object is a set of object nodes.
S204: For each object node in the target objects, virtual resources of the available resource quotas corresponding to the object node are determined as virtual resource decrements corresponding to the object node.
S206: A quota exchange transaction including the determined virtual resource decrements corresponding to the object node is constructed, and the quota exchange transaction is published to a blockchain.

In the method shown in FIG. 2, a plurality of object nodes are allowed to form a set of object nodes, and the set of object nodes is used as a unit to participate in the selection. For example, for a set of object nodes, an amount of designated remaining virtual resources corresponding to the set of object nodes is accumulated by the amount of designated remaining virtual resources corresponding to each object node in the set of object nodes. For each object node in the set of object nodes, a ratio of the amount of designated remaining virtual resources corresponding to the object node to the amount of designated remaining virtual resources corresponding to the set of object nodes is an earning ratio corresponding to the object node. For a set of object nodes, the earning ratio corresponding to each object node in the set of object nodes may be predetermined by each object node in the set of object nodes.

In the method shown in FIG. 2, the target object refers to an object node or a set of object nodes selected by the management node according to the selection rule. Various methods of determining the target node in the method shown in FIG. 1 are also applicable to determining the target object in the method shown in FIG. 2. That is, in step S200, each set of object nodes may be temporarily regarded as an object node for selection of target objects. For those skilled in the art, after understanding the foregoing description of the method shown in FIG. 1, it is easy to understand a specific implementation in which the management node selects a target object from the object node and the set of object nodes, and details are not described again.

Once a set of object nodes is selected as the target objects, each object node in the set of object nodes may jointly obtain the qualification for exchanging available resource quotas.

A manner in which available resource quotas exchanged to each object node in the target objects are determined is as follows.

The management node may determine the available resource quotas exchanged to the target objects, acquire an earning ratio corresponding to each object node in the target objects, and then for each object node in the target objects, obtain, according to the earning ratio corresponding to the object node and the available resource quotas exchanged to the target objects, the available resource quotas exchanged to the object node.

An amount of designated remaining virtual resources corresponding to the target nodes may be determined as an available resource quota exchanged to the target object. The amount of designated remaining virtual resources corresponding to the target objects is a sum of amounts of designated remaining virtual resources corresponding to each object node in the target object. For each object node, the amount of designated remaining virtual resources corresponding to the object nodes is an amount that is preassigned by the user corresponding to the object node and that is of at least one part of remaining virtual resources corresponding to the object nodes.

Alternatively, for each target object, a minimum amount of remaining virtual resources may be determined as available resource quotas exchanged to the target object. The minimum amount of remaining virtual resources is determined in the following manners: determining a minimum amount of designated remaining virtual resources from the amounts of designated remaining virtual resources respectively corresponding to each target object; and designating, as the minimum amount of remaining virtual resources, an amount not greater than the minimum amount of designated remaining virtual resources.

For each object node in the target objects, a ratio of the amount of designated remaining virtual resources corresponding to the object node to the amount of designated remaining virtual resources corresponding to the target object is calculated and used as an earning ratio corresponding to the object node.

Further, an application scenario of the method shown in FIG. 2 may be as follows. Sometimes, some object nodes participating in the selection of target nodes alone may be difficult to be selected (for example, music writers who are not popular with music listeners often earn very little musical tone coins and cannot obtain the qualification for exchanging available resource quotas). To this end, a plurality of object nodes that are difficult to be selected as target nodes may be combined into a set of object nodes and participate in the selection as a unit. Once selected as the target object, the object nodes may use virtual resources to exchange available resource quotas and then share earning increments converted from available resource quotas.

The method of selecting a representative node by each object node in the set of object nodes may be voting, a random designation method, a Monte Carlo algorithm, and the like.

The example of the music company X mentioned above is still used. Assuming that the amount of designated remaining virtual resources corresponding to a certain set of object nodes is 1200 (musical tone coins), the object nodes included in the set of object nodes are A to C. In the amount of designated remaining virtual resources of 1200, 800 musical tone coins are from an object node A, 300 musical tone coins are from an object node B, and 100 musical tone coins are from an object node C. Therefore, an earning ratio corresponding to the object node A is ⅔, an earning ratio corresponding to the object node B is ¼, and an earning ratio corresponding to the object node C is 1/12. If the set of object nodes is selected as the target object, and the available resource quota granted by the management node to the set of object nodes is 1200, then an available resource quota corresponding to the object node A is 800 (a corresponding earning increment is 80,000 yuan), an available resource quota corresponding to the object node B is 300 (a corresponding earning increment is 30,000 yuan), and an available resource quota corresponding to the object node C is 100 (a corresponding earning increment is 10,000 yuan). In addition, each object node in the set of object nodes needs to select an object node as a representative node, and when a user corresponding to the representative node provides art services for others in real life, a music company X will separately pay earning increments to object nodes A to C.

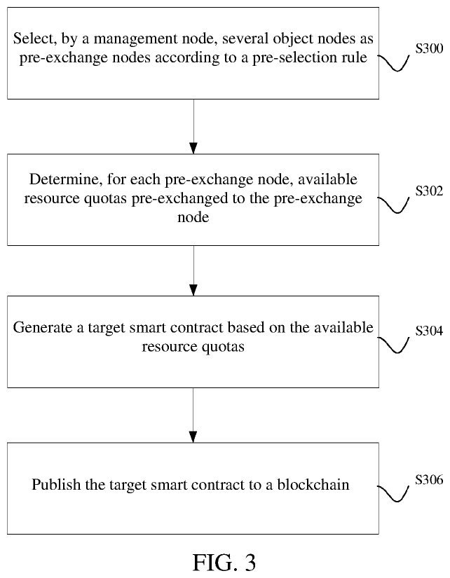

FIG. 3 is a schematic flowchart of a blockchain-based pre-exchange method for available resource quotas according to an embodiment of the specification, including the following steps.
S300: A management node selects several object nodes as pre-exchange nodes according to a selection rule.
S302: For each pre-exchange node, available resource quotas pre-exchanged to the pre-exchange node are determined.
S304: A smart target contract is generated based on the available resource quotas.
S306: The smart target contract is published to a blockchain.

In the exchange method for available resource quotas shown in FIG. 1, for each target node selected, the available resource quotas that may be exchanged by the target node are usually not greater than the amount of remaining virtual resources corresponding to the target node, otherwise the balance of payments of each object node cannot be ensured.

In the method shown in FIG. 3, the management node may further select several object nodes as pre-exchange nodes according to the pre-selection rule. For each pre-exchange node, the pre-exchange node may not be limited by corresponding remaining virtual resources to pre-exchange the available resource quotas (which may be greater than the amount of remaining virtual resources corresponding to the pre-exchange node). The available resource quotas pre-exchanged to the pre-exchange node are used for determining earning increments corresponding to the target nodes.

For example, for each pre-exchange node, the management node does not initiate a resource exchange transaction (that is, deduct the virtual resources of the pre-exchange quotas from the remaining virtual resources corresponding to the pre-exchange node), but generates a smart target contract based on the available resource quotas. The smart target contract is used to deduct the virtual resources of the available resource quotas from future increments of the virtual resources corresponding to the pre-exchange node. The future increments of the virtual resources corresponding to the pre-exchange node are virtual resource increments that are to be stored into a blockchain and that correspond to the pre-exchange node.

In other words, the management node may issue “loans” of a certain amount of virtual resources for each selected pre-exchange node. The future increments of virtual resources corresponding to the pre-exchange node are used as guarantees, and a “contract of loan” is stored in the blockchain in the form of a smart contract to ensure that the future increments of virtual resources corresponding to the pre-exchange node will be preferentially used to repay the pre-exchanged available resource quotas. In addition, for each pre-exchange node, a user corresponding to the pre-exchange node may obtain excess earnings in advance by virtue of pre-exchanged available resource quotas.

In order to make the selected pre-exchange node possess a certain repayment ability as much as possible, a specific method in which the management node selects several object nodes as pre-exchange nodes according to a selection rule includes:

determining, by the management node within each of a plurality of first cycles, for each object node, whether the amounts of virtual resource increments corresponding to the object node are all greater than a specified amount; if yes, determining the object node as a pre-exchange node; otherwise, refusing to determine the object node as the pre-exchange node. The designated amount may be specified according to actual service needs.

For example, assuming that a first cycle is one month, it may be determined that, in each month of recent three months, whether the amounts of virtual resource increments corresponding to the object node are all greater than the designated amount.

Further, a specific method of determining, within each of a plurality of first cycles, whether the amounts of virtual resource increments that correspond to the object node and that are published to the blockchain are all greater than a specified amount includes:

determining, within each of a plurality of first cycles, whether the amounts of virtual resource increments that correspond to the object node and that are generated based on copyright use transactions are all greater than the designated amount.

In addition, in the method shown in FIG. 3, the smart target contract is further used to deduct virtual resources of interest amounts from the future increments of the virtual resources corresponding to the pre-exchange node. The virtual resources of the interest amounts may be regarded as the price paid by the pre-exchange node for obtaining excess earnings in advance.

Further, for each pre-exchange node, a specific method in which the management node determines available resource quotas pre-exchanged to the pre-exchange node may be: determining, according to the amount of virtual resource increments corresponding to the pre-exchange node in each of a plurality of second cycles, available resource quotas pre-exchanged to the pre-exchange node.

For example, for a pre-exchange node, if the amount of musical tone coins that each pre-exchange node earns in each of recent three months is greater than 600, it indicates that the pre-exchange node may have a repayment ability of 600 musical tone coins in each of several coming months. Therefore, it may be determined that an available resource quota pre-exchanged to the pre-exchange node is 600.

For another example, for a pre-exchange node, if the pre-exchange node has a monthly income of more than 600 musical tone coins in the past 3 months, and a two-month income of musical tone coins less than 300, then an average value (that is, 400) of the amount of musical tone coins that the pre-exchange node has earned in each of the past 3 months may be used as the available resource quotas pre-exchanged to the pre-exchange node.

Similarly, for each pre-exchange node, the management node may determine, according to the amount of virtual resource increments corresponding to the pre-exchange node in each of a plurality of third cycles, available resource quotas pre-exchanged to the pre-exchange node.

For example, for a pre-exchange node, if the amount of musical tone coins that each pre-exchange node earns based on the copyright use transactions in each of recent three months is greater than 600, it indicates that the amount of musical tone coins that the pre-exchange node earns every month is stable, and interests corresponding to the pre-exchange node may have a relatively small amount.

For another example, for a pre-exchange node, if the pre-exchange node has a monthly income of more than 600 musical tone coins in the past 3 months, and a two-month income of musical tone coins less than 300, then it indicates that the monthly amount of musical tone coins earned by the pre-exchange node is unstable, and has a high probability of being unable to repay the pre-exchanged available resource quotas in the future. Therefore, interests corresponding to the pre-exchange node may have a relatively large amount.

The first cycle, the second cycle, and the third cycle described herein may be the same cycle or different cycles.

In the method shown in FIG. 3, a set of object nodes may also be qualified to pre-exchange available resource quotas. According to the proportion of earnings corresponding to each object node in the set of object nodes, the available resource quotas pre-exchanged by each object node in the set of object nodes are determined, and for each object node in the set of object nodes, the virtual resources (which may further include virtual resources of interest amounts) of the available resource quotas that are pre-exchanged by the object node are deducted from the future increments of the virtual resources corresponding to the object node.

In addition, those skilled in the art should understand that, in practical applications, the exchange method for available resource quotas shown in FIG. 1, the exchange method for available resource quotas shown in FIG. 2, and the exchange method for available resource quotas shown in FIG. 3 may be all implemented separately. Definitely, at least two methods may also be selected for combined use from the exchange method for available resource quotas shown in FIG. 1, the exchange method for available resource quotas shown in FIG. 2, and the exchange method for available resource quotas shown in FIG. 3, and the combined embodiment also falls within the protection scope claimed by the specification.

For example, the methods shown in FIG. 1 and FIG. 3 may be combined. For example, after the method shown in FIG. 1 is performed for each object node, that is, after each target node is selected and each target node is qualified to exchange available resource quotas, the method shown in FIG. 3 may be performed. Then, a pre-selection rule is further used to select several pre-exchange nodes from each target node, and each pre-exchange node is additionally qualified to pre-exchange available resource quotas. In this case, for each pre-exchange node, the pre-exchange node is not only eligible to use remaining virtual resources to exchange available resource quotas, but also eligible to pre-exchange more available resource quotas with the future increments of the virtual resources as a guarantee.

The example of the music company X mentioned above is still used. The management node finds, when qualifying a target node to use remaining virtual resources to exchange 1,000 available resource quotas, that the target node has generated considerable earnings (such as greater than 500) from musical tone coins in each of the past three quarters based on copyright use transactions. Therefore, the management node may further determine the target node as a pre-exchange node, further qualifying the pre-exchange node to pre-exchange 1,000 available resource quotas, and agrees, through a smart contract, with the pre-exchange node that the pre-exchange node uses future increments of virtual resources to repay the pre-exchanged available resource quotas and the corresponding interest amount (for a total of 1200 musical tone coins) in the next 3 quarters.

In addition, in the blockchain-based method for delivering virtual resources described above, the use of virtual resources may not be limited to copyright transactions, but also includes the following two aspects.

1. Any object node may use virtual resources to purchase merchandises or services from the management node.

For example, the object node may determine a payment amount, use the virtual resources of the payment amount as corresponding virtual resource decrements, construct a merchandise purchase transaction including the determined virtual resource decrements or a service purchase transaction including the determined merchandise, and publish the merchandise purchase transaction or the service purchase transaction to a blockchain.

For example, a user corresponding to an object node needs to purchase a guitar, the user may pay 100 musical tone coins to the management node through the object node, and the management node delivers a guitar to the user.

The service purchased by an object node may be a promotion right granted by the management node, the right including but not limited to that the management node sends promotion information for advertising the work of the object node to other object nodes.

2. Any object node may use virtual resources to purchase merchandises or services from a third-party device (such as an e-commerce server) in addition to other object nodes and the management node.

For example, the object node may determine the payment amount, construct a merchandise purchase request or service purchase request including the payment amount, and send the merchandise purchase request or the service purchase request to the third-party device to purchase the merchandise or service. After providing merchandises or services to the object node, the third-party device sends an exchange request including the payment amount to the management node. The management node converts the payment amount into a property amount according to the exchange request, and pays property of the property amount to the third-party device.

For example, if a music writer (an object node) wants to make a record, and needs to pay a record company (a third-party device) a production fee of 10,000 yuan, the music writer may use possessed musical tone coin for payment. For example, 100 musical tone coins (assuming that the management node stipulates that 1 musical tone coin is equivalent to 100 yuan) may be paid to the record company, and subsequently, the record company may request the management node to exchange the 100 musical tone coins, thereby obtaining a production fee of 10,000 yuan.

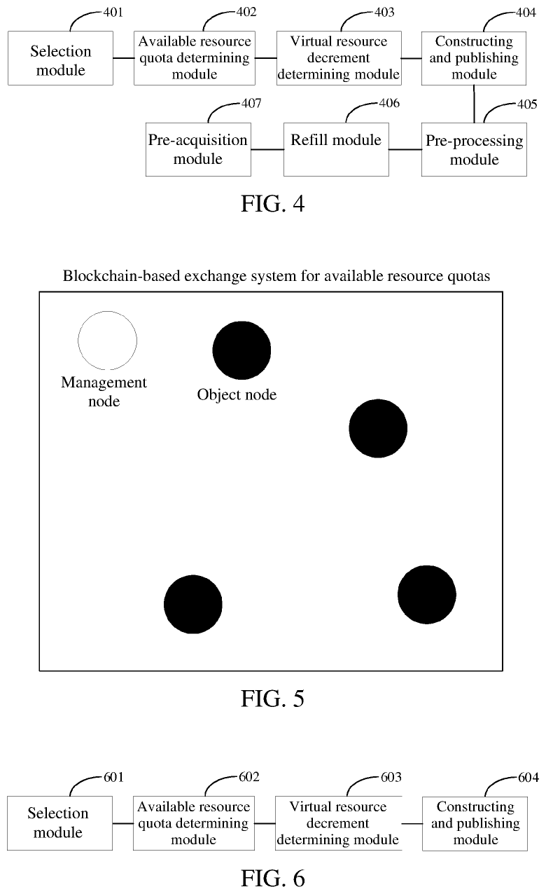

Based on the blockchain-based exchange method for available resource quotas shown in FIG. 1, the embodiment of the specification further provides a blockchain-based exchange apparatus for available resource quotas. As shown in FIG. 4, a blockchain network includes the apparatus and several object nodes, each object node performing copyright use transactions by using virtual resources issued by the apparatus as transaction media, and the apparatus includes: a selection module 401 configured to select several object nodes as target nodes according to a selection rule; an available resource quota determining module 402 configured to determine, for each target node, available resource quotas exchanged to the target nodes; the available resource quotas exchanged to the target nodes being used for determining earning increments corresponding to the target nodes; a virtual resource decrement determining module 403 configured to determine virtual resources of the available resource quotas as virtual resource decrements corresponding to the target nodes; and a constructing and publishing module 404 configured to construct a quota exchange transaction including the determined virtual resource decrements corresponding to the target nodes, and publish the quota exchange transaction to a blockchain.

The apparatus further includes: a pre-processing module 405 configured to preset several work categories, and for each work category, establish an association relationship between the several object nodes and the work category.

The selection module 401 selects, according to the selection rule for each work category, several object nodes as target nodes from the object nodes associated with the work category.

The selection module 401 is configured to invoke a smart selection contract that includes the selection rule and that is stored on the blockchain; and select the several object nodes as target nodes through the smart selection contract.

The selection module 401 is configured to determine, according to the selection rule, an object node that satisfies the selection rule as a target node; or determine, according to the selection rule, an object node that satisfies the selection rule; determine, for each object node that satisfies the selection rule, whether a user corresponding to the object node agrees to determine the object node as the target node; and if the user agrees, determine the object node as the target node.

That each object node satisfies the selection rule includes: an amount of designated remaining virtual resources corresponding to the object node is not less than a first threshold; the amount of designated remaining virtual resources corresponding to the object node being an amount that is preassigned by the user corresponding to the object node and that is of at least one part of remaining virtual resources corresponding to the object nodes; the remaining virtual resources corresponding to the object nodes being virtual resource increments remaining after the virtual resource decrements that correspond to the target nodes and that are stored on the blockchain are deducted from virtual resource increments that correspond to the object nodes and that are stored on the blockchain; and/or during a statistical period, an amount of the virtual resource increments that correspond to the object node and that are generated based on the copyright use transaction is not less than a second threshold.

The apparatus further includes: a refill module 406 configured to: receive a refill request that includes a refill amount and that is sent by any object node; deduct property equivalent to virtual resources of the refill amount from a property account of the user corresponding to the object node; determine the virtual resources of the refill amount as the virtual resource increments corresponding to the object nodes; and construct a resource refill transaction including the determined virtual resource increments corresponding to the object nodes, and publish the resource refill transaction to the blockchain.

That an amount of designated remaining virtual resources corresponding to the object nodes is not less than a first threshold includes: the amount of designated remaining virtual resources corresponding to the object nodes is not less than the first threshold, and a proportion of virtual resource increments generated based on the resource refill transaction to the remaining virtual resources of the amount of designated remaining virtual resources corresponding to the object nodes is not greater than a designated proportion.

The selection rule includes: a competitiveness representation value algorithm; the selection module 401 calculating, for each object node, a competitiveness representation value corresponding to the object node by using the competitiveness representation value algorithm; and selecting a preset quantity of object nodes as the target nodes according to a competitiveness representation value respectively corresponding to each object node, where for each object node, a larger competitiveness representation value corresponding to the object node leads to a higher priority that the object node is selected as the target node.

The selection module 401 calculates, for each object node, a competitiveness representation value corresponding to the object node by using a characteristic parameter corresponding to the object node as an input of the competitiveness representation value algorithm, where the characteristic parameter corresponding to the object node includes at least one of the following: (1) an amount of designated remaining virtual resources corresponding to the object node; the amount of designated remaining virtual resources corresponding to the object node being an amount that is preassigned by the user corresponding to the object node and that is of at least one part of remaining virtual resources corresponding to the object node; and the remaining virtual resources corresponding to the object nodes being virtual resource increments remaining after the virtual resource decrements that correspond to the target nodes and that are stored on the blockchain are deducted from virtual resource increments that correspond to the object node and that are stored on the blockchain; (2) a proportion of virtual resource increments generated based on a copyright use transaction to virtual resources of the amount of designated remaining virtual resources corresponding to the object node; and (3) during a statistical period, an amount of the virtual resource increments that correspond to the object node and that are generated based on the copyright use transaction.

The selection module 401 is configured to sort object nodes in descending order according to the competitiveness representation value respectively corresponding to each object node; select a first object node; determine whether a user corresponding to the object node agrees to determine the object node as the target node; if the user agrees, determine the object node as the target node; if the user does not agree, skip determining the object node as the target node; and select a next object node until a preset quantity of target nodes are determined.

The apparatus further includes: a pre-acquisition module 407 configured to acquire, in advance for each object node, an authorization type corresponding to the object node, the authorization type including one of a consent type, a query type, and a rejection type.

The selection module 401 is configured to: determine that a user corresponding to the object node agrees to determine the object node as a target node if the authorization type corresponding to the object node is the consent type; if the authorization type corresponding to the object node is the query type, ask whether the user corresponding to the object node agrees to determine the object node as the target node; and if the authorization type corresponding to the object node is the rejection type, determine that the user corresponding to the object node does not agree to determine the object node as the target node.

The available resource quota determining module 402 is configured to determine, for each target node, an amount of designated remaining virtual resources corresponding to the target nodes as available resource quotas exchanged to the target nodes; the amount of designated remaining virtual resources corresponding to the target nodes being an amount that is preassigned by a user corresponding to the target node and that is of at least one part of remaining virtual resources corresponding to the target node; or determine, for each target node, a minimum amount of remaining virtual resources as available resource quotas exchanged to the target node.

The minimum amount of remaining virtual resources is determined in the following manners: determining a minimum amount of designated remaining virtual resources from the amounts of designated remaining virtual resources respectively corresponding to each target node; and designating, as the minimum amount of remaining virtual resources, an amount not greater than the minimum amount of designated remaining virtual resources.

In some embodiments, the various modules of the apparatus of FIG. 4 may be implemented as software instructions or a combination of software and hardware. For example, the apparatus of FIG. 4 (or referred to as a system) may comprise one or more processors (e.g., a CPU) and one or more non-transitory computer-readable storage memories coupled to the one or more processors and configured with instructions executable by the one or more processors to cause one or more components (e.g., the one or more processors) of the system to perform various steps and methods of the modules described above (e.g., with reference to the method embodiments). In some embodiments, the apparatus of FIG. 4 may include a server, a mobile phone, a tablet computer, a PC, a laptop computer, another computing device, or a combination of one or more of these computing devices.

In some embodiments, a system comprises one or more processors and one or more non-transitory computer-readable storage media storing instructions executable by the one or more processors, wherein execution of the instructions causes the one or more processors to perform operations comprising: selecting, at a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas; determining, at the management node respectively for the plurality of target nodes, a plurality of resource quotas; determining, at the management node respectively for the plurality of target nodes, virtual resource decrements corresponding to the plurality of resource quotas; constructing, at the management node, a quota exchange transaction comprising the determined virtual resource decrements corresponding to the plurality of target nodes; and adding, at the management node, the quota exchange transaction to the blockchain.

Based on the blockchain-based exchange method for available resource quotas shown in FIG. 1, the embodiment of the specification further provides an exchange system for available resource quotas. As shown in FIG. 5, the system includes: a management node (a hollow circle) and several object nodes (solid circles), where each object node performs copyright use transactions by using virtual resources issued by the management node as transaction media; and the management node is configured to: select several object nodes as target nodes according to a selection rule; determine, for each target node, available resource quotas exchanged to the target nodes; the available resource quotas exchanged to the target nodes being used for determining earning increments corresponding to the target nodes; determine virtual resources of the available resource quotas as virtual resource decrements corresponding to the target nodes; and construct a quota exchange transaction including the determined virtual resource decrements corresponding to the target nodes, and publish the quota exchange transaction to a blockchain.

Based on the blockchain-based collective exchange method for available resource quotas shown in FIG. 2, the embodiment of the specification further provides a blockchain-based collective exchange apparatus for available resource quotas. As shown in FIG. 6, a blockchain network includes the apparatus and several object nodes, each object node performing copyright use transactions by using virtual resources issued by the apparatus as transaction media, and the apparatus includes: a selection module 601 configured to select several object nodes and/or a set of several object nodes as target objects according to a selection rule, each set of object nodes comprising more than one object node; an available resource quota determining module 602 configured to determine, for each target object, available resource quotas exchanged to each object node in the target objects if the target object is a set of object nodes; for each object node in the target objects, the available resource quotas exchanged to the object node being used for determining earning increments corresponding to the object node; a virtual resource decrement determining module 603 configured to determine, for each object node in the target objects, virtual resources of the available resource quotas corresponding to the object node as virtual resource decrements corresponding to the object node; and a constructing and publishing module 604 configured to construct a quota exchange transaction including the determined virtual resource decrements corresponding to the object node, and publish the quota exchange transaction to a blockchain.

The available resource quota determining module 602 is configured to: determine available resource quotas exchanged to the target objects; acquire an earning ratio corresponding to each object node in the target objects; and for each object node in the target objects, obtain, according to the earning ratio corresponding to the object node and the available resource quotas exchanged to the target objects, the available resource quotas exchanged to the object node.

The available resource quota determining module 602 is configured to determine an amount of designated remaining virtual resources corresponding to the target objects as available resource quotas exchanged to the target objects. The amount of designated remaining virtual resources corresponding to the target objects is a sum of amounts of designated remaining virtual resources corresponding to each object node in the target objects. For each object node, the amount of designated remaining virtual resources corresponding to the object nodes is an amount that is preassigned by the user corresponding to the object node and that is of at least one part of remaining virtual resources corresponding to the object nodes.

The available resource quota determining module 602 is configured to determine, for each target object, a minimum amount of remaining virtual resources as available resource quotas exchanged to the target objects.

The minimum amount of remaining virtual resources is determined in the following manners: determining a minimum amount of designated remaining virtual resources from the amounts of designated remaining virtual resources respectively corresponding to each target object; and designating, as the minimum amount of remaining virtual resources, an amount not greater than the minimum amount of designated remaining virtual resources.

The available resource quota determining module 602 is configured to calculate, for each object node in the target objects, a ratio of the amount of designated remaining virtual resources corresponding to the object node to the amount of designated remaining virtual resources corresponding to the target object, and use the ratio as an earning ratio corresponding to the object node.

In some embodiments, the various modules of the apparatus of FIG. 6 may be implemented as software instructions or a combination of software and hardware. For example, the apparatus of FIG. 6 (or referred to as a system) may comprise one or more processors (e.g., a CPU) and one or more non-transitory computer-readable storage memories coupled to the one or more processors and configured with instructions executable by the one or more processors to cause one or more components (e.g., the one or more processors) of the system to perform various steps and methods of the modules described above (e.g., with reference to the method embodiments). In some embodiments, the apparatus of FIG. 6 may include a server, a mobile phone, a tablet computer, a PC, a laptop computer, another computing device, or a combination of one or more of these computing devices.

Based on the blockchain-based collective exchange method for available resource quotas shown in FIG. 2, the embodiment of the specification further provides a collective exchange system for available resource quotas. As shown in FIG. 7, a blockchain network includes a management node (a hollow circle) and several object nodes (solid circles), each object node performing copyright use transactions by using virtual resources issued by the management node as transaction media.

The management node is configured to: select several object nodes and/or a set of several object nodes as target objects according to a selection rule, each set of object nodes comprising more than one object node; for each target object, if the target object is a set of object nodes, determine available resource quotas exchanged to each object node in the target objects; for each object node in the target objects, the available resource quotas exchanged to the object node being used for determining earning increments corresponding to the object node; for each object node in the target objects, determine virtual resources of the available resource quotas corresponding to the object node as virtual resource decrements corresponding to the object node; and construct quota exchange transactions including the determined virtual resource decrements corresponding to the object node, and publish the quota exchange transactions to a blockchain.

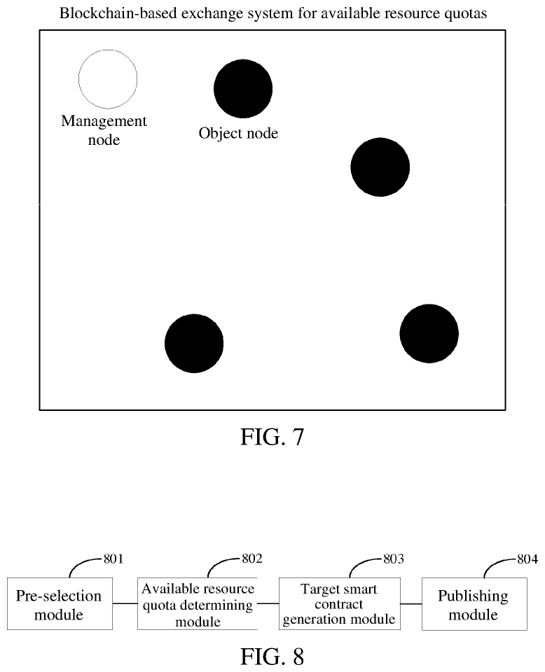

Based on the blockchain-based pre-exchange method for available resource quotas shown in FIG. 3, the embodiment of the specification further provides a blockchain-based pre-exchange apparatus for available resource quotas. As shown in FIG. 8, a blockchain network includes the apparatus node and several object nodes, each object node performing copyright use transactions by using virtual resources issued by the apparatus as transaction media, and the apparatus includes: a pre-selection module 801 configured to select several object nodes as pre-exchange nodes according to a selection rule; an available resource quota determining module 802 configured to determine, for each pre-exchange node, available resource quotas pre-exchanged to the pre-exchange node, the available resource quotas pre-exchanged to the pre-exchange node being used for determining earning increments corresponding to the target node; a smart target contract generation module 803 configured to generate a smart target contract based on the available resource quotas; the smart target contract being used to deduct the virtual resources of the available resource quotas from future increments of virtual resources corresponding to the pre-exchange node; and the future increments of the virtual resources corresponding to the pre-exchange node being virtual resource increments that are to be stored into a blockchain and that correspond to the pre-exchange node; and a publishing module 804 configured to publish the smart target contract to the blockchain.

The pre-selection module 801 is configured to: determine, for each object node within each of a plurality of first cycles, whether amounts of virtual resource increments corresponding to the object node are all greater than a designated amount; if yes, determine the object node as a pre-exchange node; or otherwise, refuse to determine the object node as the pre-exchange node.

The pre-selection module 801 is configured to determine, within each of a plurality of first cycles, whether the amounts of virtual resource increments that correspond to the object node and that are generated based on copyright use transactions are all greater than the designated amount.

The available resource quota determining module is configured to determine, according to the amount of virtual resource increments corresponding to the pre-exchange node in each of a plurality of second cycles, available resource quotas pre-exchanged to the pre-exchange node.

The smart target contract is further used to deduct virtual resources of interest amounts from the future increments of the virtual resources corresponding to the pre-exchange node. The interest amounts are determined according to the amount of virtual resource increments corresponding to the pre-exchange node in each of a plurality of third cycles.

In some embodiments, the various modules of the apparatus of FIG. 8 may be implemented as software instructions or a combination of software and hardware. For example, the apparatus of FIG. 8 (or referred to as a system) may comprise one or more processors (e.g., a CPU) and one or more non-transitory computer-readable storage memories coupled to the one or more processors and configured with instructions executable by the one or more processors to cause one or more components (e.g., the one or more processors) of the system to perform various steps and methods of the modules described above (e.g., with reference to the method embodiments). In some embodiments, the apparatus of FIG. 8 may include a server, a mobile phone, a tablet computer, a PC, a laptop computer, another computing device, or a combination of one or more of these computing devices.

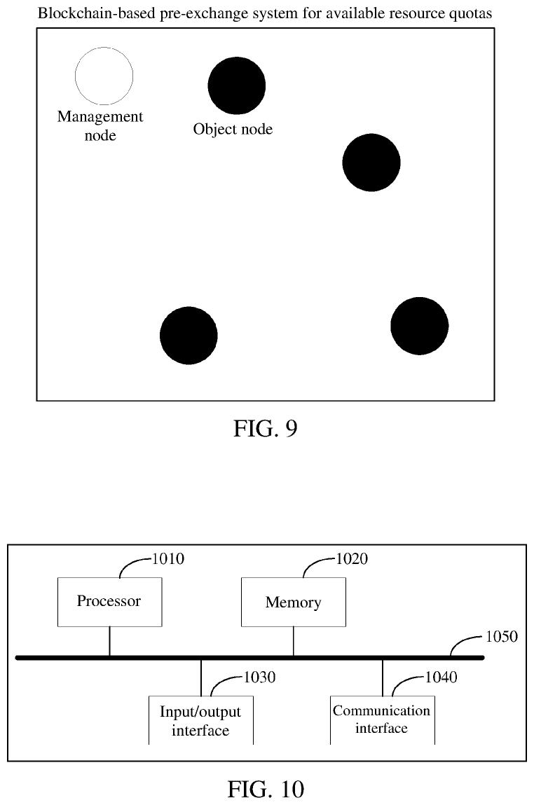

Based on the blockchain-based pre-exchange method for available resource quotas shown in FIG. 3, the embodiment of the specification further provides a blockchain-based pre-exchange system for available resource quotas. As shown in FIG. 9, a blockchain network includes a management node (a hollow circle) and several object nodes (solid circles), each object node performing copyright use transactions by using virtual resources issued by the management node as transaction media.

The management node is configured to: select several object nodes as pre-exchange nodes according to a selection rule; determine, for each pre-exchange node, available resource quotas pre-exchanged to the pre-exchange node, the available resource quotas pre-exchanged to the pre-exchange node being used for determining earning increments corresponding to the target node; generate a smart target contract based on the available resource quotas; the smart target contract being used to deduct the virtual resources of the available resource quotas from future increments of virtual resources corresponding to the pre-exchange node; and the future increments of the virtual resources corresponding to the pre-exchange node being virtual resource increments that are to be stored into a blockchain and that correspond to the pre-exchange node; and publish the smart target contract to a blockchain.

An embodiment of the specification further provides a computer device including at least a memory, a processor, and a computer program stored on the memory and executable on the processor, and the program, when executed by the processor, implements the function of the method described in FIG. 1 or FIG. 2 or FIG. 3.

FIG. 10 is a schematic diagram of a detailed hardware structure of a computing device according to an embodiment of the specification. The device may include: a processor 1010, a memory 1020, an input/output interface 1030, a communication interface 1040, and a bus 1050. Communication connection between the processor 1010, the memory 1020, the input/output interface 1030, and the communication interface 1040 in the device is implemented through the bus 1050.

The processor 1010 may be implemented by a general-purpose central processing unit (CPU), a microprocessor, an application-specific integrated circuit (ASIC), or one or more integrated circuits to execute a related program, to implement the technical solution provided in the embodiments of the specification.

The memory 1020 may be implemented by a read only memory (ROM), a random access memory (RAM), a static storage device, or a dynamic storage device. The memory 1020 may store an operating system and other application programs. When the technical solutions provided in the embodiments of the specification are implemented by software or firmware, relevant program code is stored in the memory 1020 and is called and executed by the processor 1010.

The input/output interface 1030 is used to connect an input/output module to implement information input and output. The input/output module may be configured in the device (not shown in the figure) as a component, or may be externally connected to the device to provide corresponding functions. The input device may include a keyboard, a mouse, a touch screen, a microphone, various sensors, and the like, and the output device may include a display, a speaker, a vibrator, an indicator light, and the like.

The communication interface 1040 is used to connect a communication module (not shown in the figure) to implement communication interaction between the device and other devices. The communication module may implement communication in a wired manner (for example, a Universal Serial Bus (USB) or a network cable), and may also implement communication in a wireless manner (for example, mobile network, Wireless Fidelity (Wi-Fi) or Bluetooth).

The bus 1050 includes a channel, and transmits information between components (such as the processor 1010, the memory 1020, the input/output interface 1030, and the communications interface 1040) of the device.

Although only the processor 1010, the memory 1020, the input/output interface 1030, the communication interface 1040, and the bus 1050 are shown for the above device, in a specific implementation, the device may further include other components necessary for implementing normal operation. In addition, a person skilled in the art can understand that the above device may include only components necessary to implement the solutions of the embodiments of the specification and does not necessarily include all the components shown in the drawings.

An embodiment of the specification further provides a computer-readable storage medium, storing a computer program, and when the program is executed by a processor, the function of the method described in FIG. 1 or FIG. 2 or FIG. 3 are implemented.

The computer readable medium includes a persistent medium and a non-persistent medium, a removable medium and a non-removable medium, which may implement storage of information by using any method or technology. The information may be a computer readable instruction, a data structure, a module of a program or other data. Examples of computer storage media include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that may be configured to store information that a computing device can access. Based on the definition herein, the computer-readable medium does not include transitory computer readable media (transitory media), such as a modulated data signal and a carrier.

It may be learned from description of the foregoing implementations that, a person skilled in the art may clearly understand that the embodiments of the specification may be implemented by using software in addition to a necessary universal hardware platform. Based on such an understanding, the technical solutions in the embodiments of the specification essentially, or the part contributing to the existing technologies may be implemented in a form of a software product. The computer software product may be stored in a storage medium, such as a ROM/RAM, a magnetic disk, or an optical disc, and includes several instructions for instructing a computer device (which may be a personal computer, a server, or a network device) to perform the methods described in the embodiments or some parts of the embodiments of the specification.

The system, the method, the module or the unit described in the foregoing embodiments can be implemented by a computer chip or an entity or implemented by a product having a certain function. A typical implementation device is a computer, and the specific form of the computer may be a personal computer, a laptop computer, a cellular telephone, a camera phone, a smartphone, a personal digital assistant, a media player, a navigation device, an email transceiver device, a game console, a tablet computer, a wearable device, or a combination thereof.

The embodiments in this specification are all described in a progressive manner, for same or similar parts in the embodiments, refer to these embodiments, and descriptions of each embodiment focus on a difference from other embodiments. Especially, apparatus and device embodiments are basically similar to a method embodiment, and therefore are described briefly; for related parts, refer to partial descriptions in the method embodiment. The method embodiment described above is merely exemplary, and the modules described as separate components may or may not be physically separate. When the solutions of the embodiments of the specification are implemented, the functions of the modules may be implemented in one same piece or a plurality of pieces of software and/or hardware. Some or all modules thereof may be selected based on an actual requirement, to implement an objective of the solution in this embodiment. A person of ordinary skill in the art may understand and implement the objective without creative efforts.

The foregoing is only specific implementations of the embodiments of the specification, it shall be pointed out that, a person of ordinary skill in the art may further make various improvements and embellishments without departing from the principles of the embodiments of the specification. Such improvements and embellishments shall fall within the protection scope of the embodiments of the specification.

What is claimed is:

1. A method, comprising:
selecting, by a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas;
determining, by the management node respectively for the plurality of target nodes, a plurality of resource quotas;
determining, by the management node respectively for the plurality of target nodes, virtual resource decrements corresponding to the plurality of resource quotas;
constructing, by the management node, a quota exchange transaction comprising the determined virtual resource decrements corresponding to the plurality of target nodes; and
adding, by the management node, the quota exchange transaction to the blockchain.

2. The method according to claim 1, further comprising, before selecting the plurality of object nodes as the plurality of target nodes, presetting a plurality of work categories, and for each work category, establishing an association relationship between the plurality of object nodes and the plurality of work categories, wherein:
selecting the plurality of object nodes as the plurality of target nodes comprises:
selecting the plurality of object nodes as the plurality of target nodes according to a selection rule for each of the plurality of work categories.

3. The method according to claim 1, wherein the selection rule comprises:
an amount of remaining virtual resources corresponding to an object node is not less than a first threshold; and
the remaining virtual resources corresponding to the object node correspond to a remainder after the virtual resource decrements are deducted from virtual resource increments corresponding to the object node stored on the blockchain.

4. The method according to claim 1, wherein the selection rule comprises:
during a statistical period, for each object node, an amount of the virtual resource increments generated based on copyright use transactions is not less than a second threshold.

5. The method according to claim 1, further comprising:
receiving, by the management node from an object node, a refill request comprising a refill amount;
deducting, by the management node, an amount of property equivalent to virtual resources of the refill amount from a property account corresponding to the object node;
determining, by the management node, the virtual resources of the refill amount as virtual resource increments corresponding to the object node; and
constructing, by the management node, a resource refill transaction comprising the determined virtual resource increments corresponding to the object node, and adding the resource refill transaction to the blockchain;
wherein the selection rule comprises that: (1) an amount of remaining virtual resources corresponding to the object node is not less than a first threshold, and (2) a proportion of virtual resource increments corresponding to the object node being generated based on resource refill transactions is not greater than a designated proportion.

6. The method according to claim 1, wherein:
the selection rule comprises a competitiveness representation value algorithm;
selecting the plurality of object nodes as the plurality of target nodes comprises:
determining, by the management node for each object node, a competitiveness representation value by using the competitiveness representation value algorithm, and
selecting a preset quantity of object nodes as the target nodes according to the competitiveness representation value respectively corresponding to the each object node; and
for the each object node, a larger competitiveness representation value increases a chance of being selected as a target node.

7. The method according to claim 6, wherein determining, by the management node for the each object node, the competitiveness representation value by using the competitiveness representation value algorithm comprises:
determining, by the management node for the each object node, the competitiveness representation value by using a characteristic parameter corresponding to the object node as an input of the competitiveness representation value algorithm, wherein the characteristic parameter corresponding to the object node comprises:
(1) an amount of remaining virtual resources corresponding to the object node, the virtual resource remaining virtual resources corresponding to the object node corresponding to a remainder after the virtual resource decrements are deducted from virtual resource increments corresponding to the object node stored on the blockchain;
(2) a proportion of virtual resource increments generated based on copyright use transactions to virtual resources of the amount of remaining virtual resources corresponding to the object node; and
(3) during a statistical period, for the each object node, an amount of the virtual resource increments generated based on copyright use transactions.

8. The method according to claim 6, wherein selecting the preset quantity of object nodes as the target nodes according to the competitiveness representation value respectively corresponding to the each object node comprises:
sorting the plurality of object nodes in a descending order according to the competitiveness representation value; and
selecting, from a first object node according to the descending order, one or more object nodes agreed by one or more corresponding users to become target nodes until a preset quantity of target nodes are selected.

9. The method according to claim 8, further comprising, before selecting the plurality of object nodes as the plurality of target nodes, acquiring by the management node in advance for each object node, an authorization type corresponding to the object node, the authorization type comprising a consent type, a query type, or a rejection type; and
selecting, from the first object node according to the descending order, the one or more object nodes agreed by the one or more corresponding users to become target nodes until the preset quantity of target nodes are selected comprises:
if the authorization type is the consent type, determining that a corresponding user agrees to determine the user's object node as the target node;
if the authorization type is the query type, asking whether the corresponding user agrees to determine the user's object node as the target node; and
if the authorization type is the rejection type, determining that the corresponding user does not agree to determine the user's object node as the target node.

10. The method according to claim 1, wherein determining, by the management node respectively for the plurality of target nodes, the plurality of resource quotas comprises:
determining, for each target node, an amount of remaining virtual resources corresponding to the each target nodes as a resource quota.

11. The method according to claim 1, wherein determining, by the management node respectively for the plurality of target nodes, the plurality of resource quotas comprises:
determining a minimum amount of designated remaining virtual resources from a plurality of amounts of designated remaining virtual resources corresponding to the target nodes;
designating, as a minimum amount of remaining virtual resources, an amount not greater than the minimum amount of designated remaining virtual resources; and
determining, for each target node, the minimum amount of remaining virtual resources as a resource quota.

12. A non-transitory computer-readable storage medium storing instructions executable by one or more processors, wherein execution of the instructions causes the one or more processors to perform operations comprising:
selecting, at a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas;
determining, at the management node respectively for the plurality of target nodes, a plurality of resource quotas;
determining, at the management node respectively for the plurality of target nodes, virtual resource decrements corresponding to the plurality of resource quotas;
constructing, at the management node, a quota exchange transaction comprising the determined virtual resource decrements corresponding to the plurality of target nodes; and
adding, at the management node, the quota exchange transaction to the blockchain.

13. The non-transitory computer-readable storage medium according to claim 12, wherein the operations further comprise, before selecting the plurality of object nodes as the plurality of target nodes, presetting a plurality of work categories, and for each work category, establishing an association relationship between the plurality of object nodes and the plurality of work categories, wherein:
selecting the plurality of object nodes as the plurality of target nodes comprises: selecting the plurality of object nodes as the plurality of target nodes according to a selection rule for each of the plurality of work categories.

14. The non-transitory computer-readable storage medium according to claim 12, wherein the selection rule comprises:
an amount of remaining virtual resources corresponding to an object node is not less than a first threshold; and
the remaining virtual resources corresponding to the object node correspond to a remainder after the virtual resource decrements are deducted from virtual resource increments corresponding to the object node stored on the blockchain.

15. The non-transitory computer-readable storage medium according to claim 12, wherein the selection rule comprises:
during a statistical period, for each object node, an amount of the virtual resource increments generated based on copyright use transactions is not less than a second threshold.

16. The non-transitory computer-readable storage medium according to claim 12, wherein the operations further comprise:
receiving, at the management node from an object node, a refill request comprising a refill amount;
deducting, at the management node, an amount of property equivalent to virtual resources of the refill amount from a property account corresponding to the object node;
determining, at the management node, the virtual resources of the refill amount as virtual resource increments corresponding to the object node; and
constructing, at the management node, a resource refill transaction comprising the determined virtual resource increments corresponding to the object node, and adding the resource refill transaction to the blockchain;
wherein the selection rule comprises that: (1) an amount of remaining virtual resources corresponding to the object node is not less than a first threshold, and (2) a proportion of virtual resource increments corresponding to the object node being generated based on resource refill transactions is not greater than a designated proportion.

17. The non-transitory computer-readable storage medium according to claim 12, wherein:
the selection rule comprises a competitiveness representation value algorithm;
selecting the plurality of object nodes as the plurality of target nodes comprises:
determining, at the management node for each object node, a competitiveness representation value by using the competitiveness representation value algorithm, and
selecting a preset quantity of object nodes as the target nodes according to the competitiveness representation value respectively corresponding to the each object node; and
for the each object node, a larger competitiveness representation value increases a chance of being selected as a target node.

18. The non-transitory computer-readable storage medium according to claim 17, wherein determining, at the management node for the each object node, the competitiveness representation value by using the competitiveness representation value algorithm comprises:
determining, at the management node for the each object node, the competitiveness representation value by using a characteristic parameter corresponding to the object node as an input of the competitiveness representation value algorithm, wherein the characteristic parameter corresponding to the object node comprises:
(1) an amount of remaining virtual resources corresponding to the object node, the virtual resource remaining virtual resources corresponding to the object node corresponding to a remainder after the virtual resource decrements are deducted from virtual resource increments corresponding to the object node stored on the blockchain;
(2) a proportion of virtual resource increments generated based on copyright use transactions to virtual resources of the amount of remaining virtual resources corresponding to the object node; and
(3) during a statistical period, for the each object node, an amount of the virtual resource increments generated based on copyright use transactions.

19. The non-transitory computer-readable storage medium according to claim 17, wherein selecting the preset quantity of object nodes as the target nodes according to the competitiveness representation value respectively corresponding to the each object node comprises:
sorting the plurality of object nodes in a descending order according to the competitiveness representation value; and
selecting, from a first object node according to the descending order, one or more object nodes agreed by one or more corresponding users to become target nodes until a preset quantity of target nodes are selected.

20. A system, comprising one or more processors and one or more non-transitory computer-readable storage media storing instructions executable by the one or more processors, wherein execution of the instructions causes the one or more processors to perform operations comprising:
selecting, at a management node of a blockchain computer network, a plurality of object nodes from a group of object nodes as a plurality of target nodes according to a selection rule by invoking a smart contract stored on a blockchain, wherein the blockchain is on the blockchain computer network, the smart contract comprises the selection rule, and the target nodes are qualified to receive resources quotas;
determining, at the management node respectively for the plurality of target nodes, a plurality of resource quotas;
determining, at the management node respectively for the plurality of target nodes, virtual resource decrements corresponding to the plurality of resource quotas;
constructing, at the management node, a quota exchange transaction comprising the determined virtual resource decrements corresponding to the plurality of target nodes; and
adding, at the management node, the quota exchange transaction to the blockchain.
